(19) United States
(12) Patent Application Publication
(10) Pub. No.: US 2015/0172216 A1
(43) Pub. Date: Jun. 18, 2015

(54) DETERMINING RULES FOR PARTITIONING INTERNET CONNECTION BANDWIDTH

(71) Applicant: International Business Machines Corporation, Armonk, NY (US)

(72) Inventors: Valerio Bellizia, Carpineto Romano (IT); Luigi Pichetti, Rome (IT); Marco Secchi, Rome (IT); Stefano Sidoti, Rome (IT)

(73) Assignee: International Business Machines Corporation, Armonk, NY (US)

(21) Appl. No.: 14/109,986

(22) Filed: Dec. 18, 2013

(51) Int. Cl. H04L 12/911

(52) U.S. Cl. CPC H04L 47/826

(57) ABSTRACT

Embodiments of the present invention disclose a computer implemented method, computer program product, and system for determining rules for partitioning internet connection bandwidth. In one embodiment, in accordance with the present invention, the computer implemented method includes the steps of identifying static bandwidth partitioning policies that correspond to a cluster of users, wherein the static bandwidth partitioning policies are based on time schedules, quality of service requirements, an amount of internet connection bandwidth paid for by a user, and proportional quotas of internet connection bandwidth, identifying historical bandwidth usage data corresponding to the cluster of users, and determining bandwidth partitioning rules for the cluster of users based on the identified static bandwidth partitioning policies and identified historical bandwidth usage data. In another embodiment, the method further includes the step of applying the determined bandwidth partitioning rules to the cluster of users.

### FIELD OF THE INVENTION

The present invention relates generally to the field of internet connection, and more particularly to management of internet connection bandwidth.

### BACKGROUND

An internet service provider (ISP) is a business or organization that offers users access to the Internet and related services. Internet service providers may be organized in various forms, such as commercial, community-owned, non-profit, or privately owned. An individual, or a group of individuals, subscribe to an internet service provider in order to receive an Internet connection. Internet service providers provide services such as Internet access, domain name registration and hosting, dial-up access, and leased line access.

Internet service providers can allocate a static amount of internet connection bandwidth to the subscribers. Bandwidth is a measurement of bit-rate of available or consumed data communication resources, and can be used to define channel capacity, net bit rate, or the maximum throughput of a communication path. In many instances, individuals do not utilize the complete amount of internet connection bandwidth that is allocated by the internet service provider, which leads to the unused bandwidth being wasted. Internet connection bandwidth is also based on the type of internet connection technology that is utilized (e.g., modem/dial-up connection, digital subscriber line (DSL), etc.).

### SUMMARY

Embodiments of the present invention disclose a computer implemented method, computer program product, and system for determining rules for partitioning internet connection bandwidth. In one embodiment, in accordance with the present invention, the computer implemented method includes the steps of identifying static bandwidth partitioning policies that correspond to a cluster of users, wherein the static bandwidth partitioning policies are based on time schedules, quality of service requirements, an amount of internet connection bandwidth paid for by a user, and proportional quotas of internet connection bandwidth, identifying historical bandwidth usage data corresponding to the cluster of users, and determining bandwidth partitioning rules for the cluster of users based on the identified static bandwidth partitioning policies and identified historical bandwidth usage data. In another embodiment, the method further includes the step of applying the determined bandwidth partitioning rules to the cluster of users.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is a flowchart depicting operational steps of a program for determining bandwidth partitioning rules, in accordance with an embodiment of the present invention.

FIG. 3 depicts a block diagram of components of the computing system of FIG. 1 in accordance with an embodiment of the present invention.

### DETAILED DESCRIPTION

Embodiments of the present invention allow for determining bandwidth partitioning rules for users in a user cluster. In one embodiment, the user clusters can be dynamically defined by physical proximity of users. The bandwidth partitioning rules are determined based on identified historical usage data, and static policies that correspond to each user in the user cluster.

Embodiments of the present invention recognize that individuals do not always utilize the complete amount of internet connection bandwidth that is allocated by an internet service provider, which leads to the unused bandwidth being wasted. A plurality of users, in a similar physical area, may each have an individual contract with an internet service provider that allocated the individual a static amount of internet connection bandwidth. In such instances, the offerings of internet connection bandwidth can be oversized in comparison to the actual usage, which leads to underutilization of the available (and already paid for) internet connection bandwidth.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, or semiconductor system, apparatus, or device, or any suitable combination of the foregoing. More specific examples (a non-exhaustive list) of a computer-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

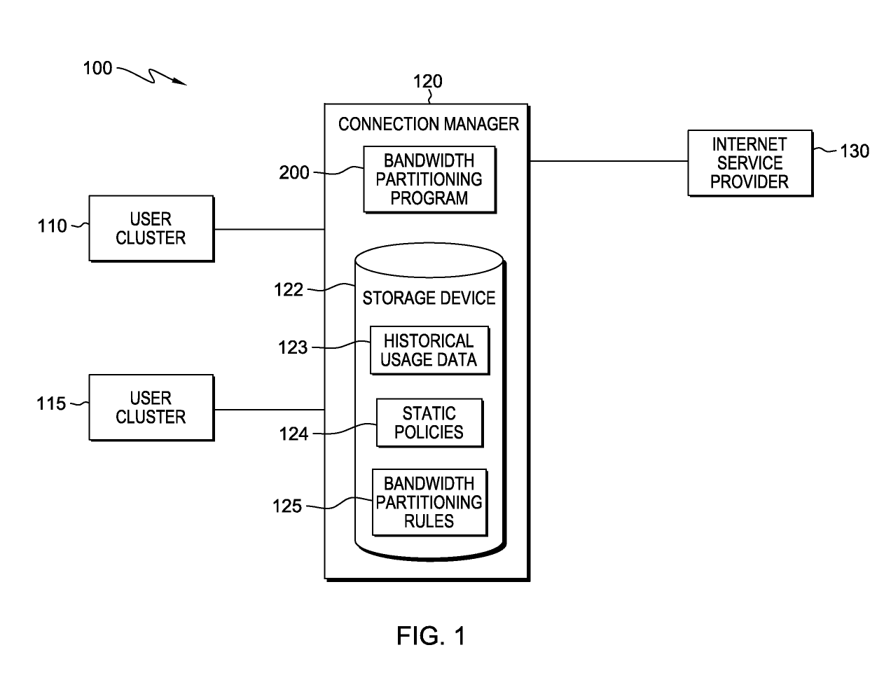

The present invention will now be described in detail with reference to the Figures. FIG. 1 is a functional block diagram illustrating a distributed data processing environment 100, in accordance with one embodiment of the present invention.

An embodiment of data processing environment 100 includes user clusters 110 and 115, connection manager 120, and internet service provider 130, all interconnected over network communications. In one embodiment, user clusters 110 and 115, connection manager 120, and internet service provider 130 communicate through network communications. Network communications can be, for example, a local area network (LAN), a telecommunications network, a wide area network (WAN) such as the Internet, or a combination of the three, and include wired, wireless, or fiber optic connections. In general, network communications can be any combination of connections and protocols that will support communications between user clusters 110 and 115, connection manager 120, and internet service provider 130 in accordance with embodiments of the present invention.

In one embodiment, user clusters 110 and 115 are clusters of individuals that utilize internet bandwidth provided by internet service provider 130. Individuals included within user cluster 110 and 115 can be defined dynamically based on physical proximity of the individuals. For example, user cluster 110 can be a grouping of a plurality of families, located on the same floor of a building, that utilize internet bandwidth provided by internet service provider 130. In example embodiments, internet service provider 130 provides a fixed amount of bandwidth to user cluster 110, and the bandwidth is partitioned among the individuals in user cluster 110. In various embodiments of the present invention, user clusters 110 and 115 include individuals utilizing computing devices to access internet bandwidth provided by internet service provider 130, which may include workstations, personal computers, personal digital assistants, mobile phones, or any other devices capable of executing program instructions in accordance with embodiments of the present invention. In one embodiment, the individuals of user cluster 110 or 115 can agree on a contract with internet service provider 130, which provides the individuals with an internet connection and a specified amount of internet bandwidth. In another embodiment, where user clusters 110 and 115 represent groupings of individuals within an apartment complex, a manager of the apartment complex can agree on a contract with internet service provider 130, which provides the individuals of user clusters 110 and 115 an internet connection and a specified amount of internet bandwidth.

In one embodiment, connection manager 120 partitions and allocates quotas of internet bandwidth from internet service provider 130 to user clusters 110 and 115. Connection manager 120 receives bandwidth usage activity from the individuals in user clusters 110 and 115. For example, connection manager 120 receives internet usage activity of all users of internet bandwidth in user clusters 110 and 115. The internet usage activity is associated with an individual user, or a group of individual users (e.g., a family within a user cluster, an apartment number within an apartment complex, etc.).

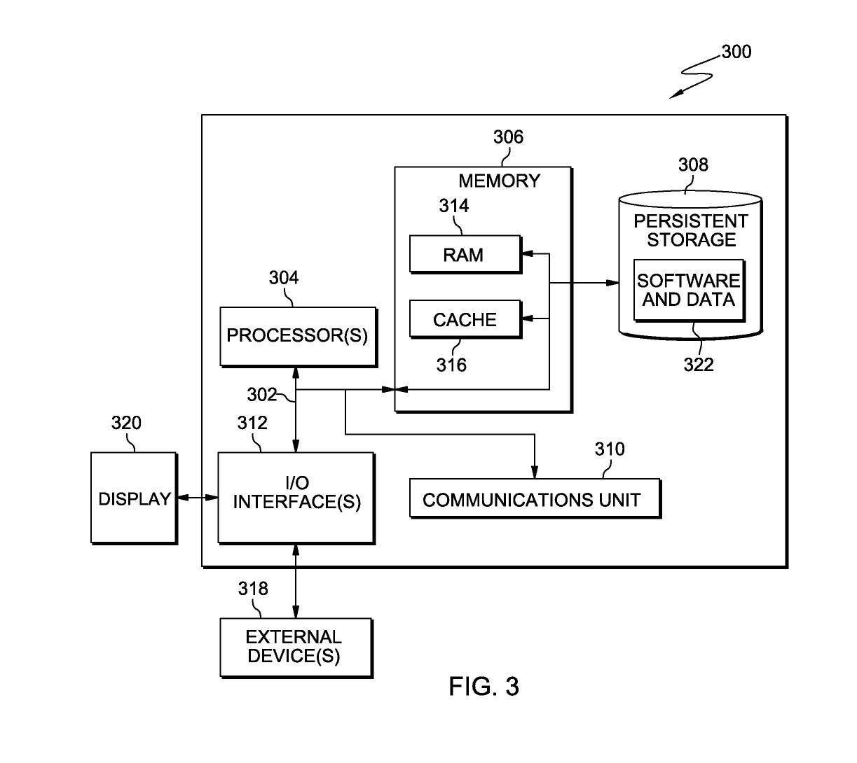

In example embodiments, connection manager 120 can be a desktop computer, computer server, or any other computer system known in the art capable of performing functions in accordance with embodiments of the present invention. In certain embodiments, connection manager 120 represents computer systems utilizing clustered computers and components (e.g., database server computers, application server computers, etc.), that act as a single pool of seamless resources when accessed by elements of data processing environment 100 (e.g., user clusters 110 and 115 and internet service provider 130). In general, connection manager 120 is representative of any electronic device or combination of electronic devices capable of executing machine-readable program instructions, as described in greater detail with regard to FIG. 3, in accordance with embodiments of the present invention.

Connection manager 120 includes storage device 122 and bandwidth partitioning program 200. Storage device 122 can be implemented with any type of storage device, for example, persistent storage 308, which is capable of storing data that may be accessed and utilized by user clusters 110 and 115, connection manager 120, and internet service provider 130, such as a database server, a hard disk drive, or flash memory. In other embodiments, storage device 122 can represent multiple storage devices within connection manager 120. In example embodiments, bandwidth partitioning program 200 determines bandwidth partitioning rules for user clusters, in accordance with embodiments of the present invention.

In one embodiment, storage device 122 includes historical usage data 123, static policies 124, and bandwidth partitioning rules 125. Connection manager 120 receives and analyzes internet usage activity of the internet users in user clusters 110 and 115, and stores the internet usage activity in historical usage data 123. Each instance of internet usage activity stored in historical usage data 123 is stored with an associated indication of the corresponding user (or group of users), application, amount of bandwidth utilized, duration of time, time of day, and other information corresponding to the instance of internet usage. In one example, an individual in user cluster 110 utilizes an application to stream video for one hour, at 8 PM. Connection manager 120 receives the internet usage activity of the individual, and stores the internet usage activity as an instance of historical usage data 123 associated with the family of the individual in user cluster 110, and includes the corresponding details of the internet usage activity (i.e., the streaming video application, one hour, 8 PM, and the amount of bandwidth utilized).

Static policies 124 are bandwidth partitioning policies that can be based on quality of service, time schedules, an amount of bandwidth paid for by a user, and proportional quotas of bandwidth. In one embodiment, static policies 124 can be defined by an administrator associated with connection manager 120 or internet service provider 130. Static policies 124 can be associated with user clusters 110 and 115, and individuals, or groups of individuals within user cluster 110 and 115. In one example, an individual in user cluster 110 can have a subscription for an increased amount of bandwidth. Then, static policies 124 can indicate a minimum amount of bandwidth that can be allocated to the individual (e.g., 10 megabits per second (Mbit/s)). In another example, for quality of service purposes, an instance of static policies 124 can be associated with an application, and indicate a minimum or maximum amount of bandwidth to allocate to an individual that is utilizing the application. Then, static policies 124 can indicate a minimum or maximum amount of bandwidth that can be allocated to an individual utilizing the application (e.g., allocate an individual in user cluster 110 at least 5 Mbit/s for Application A, allocate an individual in user cluster 115 at most 6 Mbit/s for Application B, etc.).

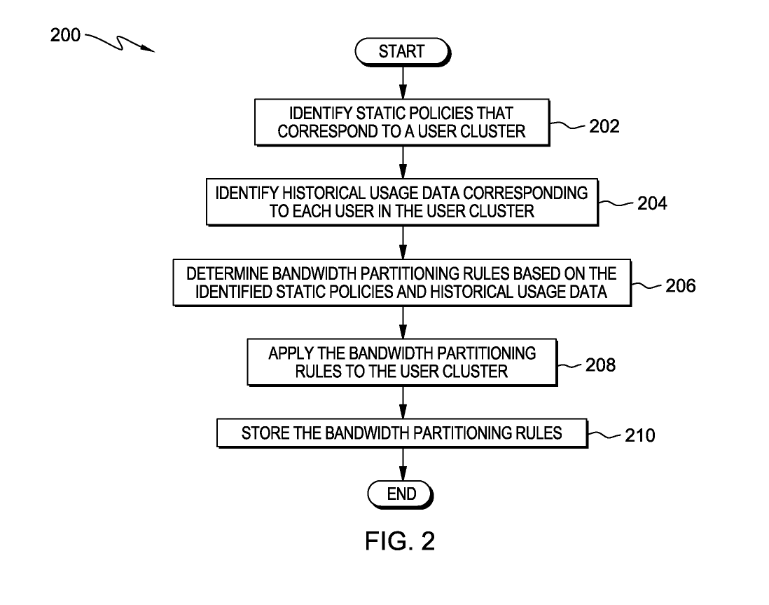

In various embodiments, static policies 124 can include associated time schedules. For example, an instance of static policies 124 can indicate a minimum or maximum amount of bandwidth to allocate to an individual during a certain time frame (e.g., allocate an individual in user cluster 110 at least 8 Mbit/s from 6 AM to 2 PM). In example embodiments, bandwidth partitioning program 200 determines instances of bandwidth partitioning rules 125 corresponding to user clusters 110 and 115 (discussed in further detail with regard to FIG. 2). Bandwidth partitioning rules 125 are stored in storage device 125 associated with the corresponding user cluster (e.g., user cluster 110 or 115).

Internet service provider 130 provides internet connection bandwidth to user clusters 110 and 115, which is managed by connection manager 120. Internet service provider 130 can allocate a static amount of internet connection bandwidth to subscribers (i.e., user clusters 110 and 115). Bandwidth is a measurement of bit-rate of available or consumed data communication resources, and can be used to define channel capacity, net bit rate, or the maximum throughput of a communication path.

FIG. 2 is a flowchart depicting operational steps of bandwidth partitioning program 200 in accordance with an embodiment of the present invention. In one embodiment, bandwidth partitioning program 200 initiates responsive to a definition of a user cluster (e.g., a dynamic definition of user cluster 110 based on physical proximity of individuals). In another embodiment, bandwidth partitioning program 200 can operate to reevaluate bandwidth partitioning rules (e.g., bandwidth partitioning rules 125). To reevaluate bandwidth partitioning rules, bandwidth partitioning program 200 can initiate at a certain time (e.g., 2 AM, or another time of day that can be defined), and responsive to historical usage data 123 meeting certain conditions (e.g., a change in bandwidth usage corresponding to a certain time frame).

In step 202, bandwidth partitioning program 200 identifies static policies that correspond to a user cluster. In one embodiment, bandwidth partitioning program 200 identifies all instances of static policies 124 (stored in storage device 122) that are associated with a user cluster (i.e., user cluster 110 or 115). In example embodiments, bandwidth partitioning program 200 identifies static policies 124, which include policies corresponding to quality of service, time schedules, and proportional quotas of bandwidth (examples discussed in further detail with regard to FIG. 1). Each user cluster (e.g., user clusters 110 and 115) can have different associated instances of static policies.

In step 204, bandwidth partitioning program 200 identifies historical usage data corresponding to each user in the user cluster. In one embodiment, bandwidth partitioning program 200 identifies historical usage data 123 in storage device 122 that corresponds to usage cluster 110 or 115. In the previously discussed example, an individual in user cluster 110 utilizes an application to stream video for one hour, at 8 PM. The corresponding instance of historical usage data 123 is associated with the family of the individual in user cluster 110 and includes the corresponding details of the internet usage activity (i.e., the streaming video application, one hour, 8 PM, and the amount of bandwidth utilized). In example embodiments, bandwidth partitioning program 200 identifies all instances of historical internet traffic in historical usage data 123 that is associated with individuals in user cluster 110, which includes the individual utilizing an application to stream video for one hour, at 8 PM.

In step 206, bandwidth partitioning program 200 determines bandwidth partitioning rules based on the identified static policies and historical usage data. In one embodiment, the determined bandwidth partitioning rules (e.g., bandwidth partitioning rules 125) correspond to user cluster 110 or 115 as a whole, and include internet connection bandwidth quotas for each user, or group of users, in user cluster 110 or 115. Bandwidth partitioning program 200 utilizes identified static policies 124 (step 202), and identified historical usage data 123 (step 204) to determine bandwidth partitioning rules 125 corresponding to a user cluster (i.e., user cluster 110 or 115). Bandwidth partitioning program 200 can utilize historical usage data for user cluster 110 and 115 to propose an adaptive allocation of internet bandwidth based on forecasting internet bandwidth usage of user clusters 110 and 115. In an example embodiment, bandwidth partitioning program 200 utilizes static policies 124 as an initial set of rules, and can customize bandwidth allocation based on historical usage data 123.

In various embodiments, bandwidth partitioning policies 124 include bandwidth quotas for each individual, or group of individuals, in user clusters 110 and 115 based on identified static policies 124 (step 202), and identified historical usage data 123 (step 204), and include an indication of time schedules that correspond to the bandwidth quotas. The bandwidth quotas are a percentage of the total available internet connection bandwidth that is allocated to a user in user cluster 110 or 115, and can change depending on a time schedule. In various embodiments, bandwidth partitioning program 200 can determine different sets of bandwidth partitioning rules 125 corresponding to different time intervals (e.g., a time schedule), and based on static policies 124 and historical usage data 123. In example embodiments, determined bandwidth partitioning rules 125 include internet connection bandwidth quotas for each individual or group of individuals in the cluster of users and an indication of activation and deactivation times.

In an example, bandwidth partitioning program 200 utilizes static policies 124 corresponding to user cluster 110 to determine an initial set of bandwidth partitioning rules 125 for user cluster 110. Then, bandwidth partitioning program 200 can customize the initial set of bandwidth partitioning rules 125 based on historical usage data 123, which is associated with users, or groups of users within user cluster 110. Bandwidth partitioning program 200 can customize bandwidth partitioning rules 125 based on a time schedule of internet bandwidth usage in historical usage data 123. For example, if a group of users (e.g., a family in an apartment) in user cluster 110 has associated historical usage data 123 that indicates a peak internet bandwidth utilization during the time period of 11 PM to 3 AM, then bandwidth partitioning program 200 can update the initial set of bandwidth partitioning rules 125 to reflect historical usage data 123 of the group of users. In various embodiments, bandwidth partitioning program 200 utilizes historical usage data 123 to determine weighting factors based on historical usage data 123 corresponding to users in user cluster 110 or 115. The weighting factors can be associated with certain time intervals (e.g., 10 AM to 3 PM, 8 PM to 11 PM, etc.), and be different for each user, or group of users, based on historical usage data 123.

In an example embodiment, bandwidth partitioning program 200 can utilize the following equation to assign bandwidth allocation quotas to user cluster 110 and 115 with “n” number of users:

$${\sum }_{x = 0}^{x = n - 1} {( Quota )}_{x} = {( K ( H + S ) )}_{x}$$

where 0<Quota≦1, H is historical usage data 123, S is a constant that depends on the time schedule, and K is a constant that depends on factors of static policies 124 (e.g., quality of service policies, and a user paying for a minimum amount of bandwidth). The “Quota” is calculated for each user (i.e., individual or group of individuals in user cluster 110 or 115) in a user cluster as a percentage of the total available internet connection bandwidth, and the summation of the “Quotas” is equal to one (i.e., the total available internet connection bandwidth). The “K” constant is a real number between zero and one, and the “S” constant is calculated from the actual time schedule.

In one example, User A and User B are the users in user cluster 110, and User A has paid to have an increased bandwidth, which is indicated in the associated instance of static policies 124. The “K” constant associated with User A is K=0.6, and the “K” constant associated with User B is K=0.4. In this example, the time schedule (can also be indicated in the associated instance of static policies 124) indicates that User B is allocated 80% of the available internet connection bandwidth. The “S” constant associated with User A is S=(0.2*available internet connection bandwidth), and the “S” constant associated with User B is S=(0.8*available internet connection bandwidth). In this example, the “H” values for User A and User B are based on historical usage data 123 that corresponds to each user. Bandwidth partitioning program 200 determines the bandwidth quota for User A and User B as a percentage of the total available internet connection bandwidth, based on the determined values. In example embodiments where bandwidth quotas change depending on the time schedule, the bandwidth quotas for each period of time (e.g., each hour long interval) add up to one (i.e., the full value of available internet connection bandwidth). Bandwidth partitioning program 200 can determine the “H” values as weighted values corresponding to historical usage data 123 that corresponds to users in user clusters 110 and 115.

In step 208, bandwidth partitioning program 200 applies the bandwidth partitioning rules to the user cluster. In one embodiment, bandwidth partitioning program 200 applies bandwidth partitioning rules 125 (determined in step 206) to the corresponding user cluster (e.g., user cluster 110 or 115).

In step 210, bandwidth partitioning program 200 stores the bandwidth partitioning rules. In one embodiment, bandwidth partitioning program 200 stores bandwidth partitioning rules 125 (determined in step 206) in storage device 122. Bandwidth partitioning rules 125 can include an indication of activation and deactivation times, and can be reevaluated based on historical usage data 123.

FIG. 3 depicts a block diagram of components of computer 300, which is representative of connection manager 120 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computer 300 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are examples of computer-readable tangible storage devices. A storage device is any piece of hardware that is capable of storing information, such as, data, program code in functional form, and/or other suitable information on a temporary basis and/or permanent basis. In this embodiment, memory 306 includes random access memory (RAM) 314 and cache memory 316. In general, memory 306 can include any suitable volatile or non-volatile computer-readable storage device. Software and data 322 are stored in persistent storage 308 for access and/or execution by processors 304 via one or more memories of memory 306. With respect to connection manager 120, software and data 322 represents historical usage data 123, static policies 124, bandwidth partitioning rules 125, and bandwidth partitioning program 200.

In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices. In these examples, communications unit 310 may include one or more network interface cards. Communications unit 310 may provide communications through the use of either or both physical and wireless communications links. Software and data 322 may be downloaded to persistent storage 308 through communications unit 310.

I/O interface(s) 312 allows for input and output of data with other devices that may be connected to computer 300. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data 322 can be stored on such portable computer-readable storage media and can be loaded onto persistent storage 308 via I/O interface(s) 312. I/O interface(s) 312 also can connect to a display 320.

Display 320 provides a mechanism to display data to a user and may be, for example, a computer monitor. Display 320 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1-7. (canceled)

8. A computer program product for determining rules for partitioning internet connection bandwidth, including one or more computer-readable storage media and program instructions stored on at least one of the one or more storage media, wherein execution of the program instructions by one or more processors of a computer system causes the one or more processors to carry out the acts of:
identifying static bandwidth partitioning policies that correspond to a cluster of users, wherein the static bandwidth partitioning policies are based on time schedules, quality of service requirements, an amount of internet connection bandwidth paid for by a user, and proportional quotas of internet connection bandwidth;
identifying historical bandwidth usage data corresponding to the cluster of users; and
determining bandwidth partitioning rules for the cluster of users based on the identified static bandwidth partitioning policies and identified historical bandwidth usage data.

9. The computer program product in accordance with claim 8, wherein execution of the program instructions by the one or more processors of the computer system causes the one or more processors to carry out the additional act of:
applying the determined bandwidth partitioning rules to the cluster of users.

10. The computer program product in accordance with claim 8, wherein the cluster of users are a group of users that receive internet connection bandwidth from an internet service provider and are clustered based on physical proximity.

11. The computer program product in accordance with claim 8, wherein the identified static policies are associated with each individual, or group of individuals, within the cluster of users and indicate a minimum or maximum amount of internet connection bandwidth to allocate to each individual or group of individuals.

12. The computer program product in accordance with claim 8, wherein execution of the program instructions by the one or more processors of the computer system causes the one or more processors to carry out the additional acts of:
receiving, for each individual or group of individuals in the cluster of users, historical bandwidth usage data,
wherein the received historical bandwidth usage data is stored and includes an associated indication of the corresponding user or group of users, application, amount of bandwidth utilizes, duration of time, and time of day.

13. The computer program product in accordance with claim 8, wherein program instructions for determining bandwidth partitioning rules for the cluster of users based on the identified static bandwidth partitioning policies and identified historical bandwidth usage data further comprises program instructions to carry out the additional acts of:
utilizing the identified static bandwidth partitioning policies as an initial set of bandwidth partitioning rules; and
customizing the initial set of bandwidth partitioning rules based on the identified historical bandwidth usage data,
wherein the determined bandwidth partitioning rules include internet connection bandwidth quotas for each individual or group of individuals in the cluster of users and an indication of activation and deactivation times.

14. The computer program product in accordance with claim 8, wherein execution of the program instructions by the one or more processors of the computer system causes the one or more processors to carry out the additional acts of:
responsive to receiving an updated instance of historical bandwidth usage data, determining an updated set of bandwidth partitioning rules based on the identified static bandwidth partitioning policies and the received updated historical bandwidth usage data.

15. A computer system for determining rules for partitioning internet connection bandwidth, the computer system comprising:
one or more computer processors;
one or more computer-readable storage media; and
program instructions stored on the computer-readable storage media for execution by at least one of the one or more processors, the program instructions comprising:
program instructions to identify static bandwidth partitioning policies that correspond to a cluster of users, wherein the static bandwidth partitioning policies are based on time schedules, quality of service requirements, an amount of internet connection bandwidth paid for by a user, and proportional quotas of internet connection bandwidth;
program instructions to identify historical bandwidth usage data corresponding to the cluster of users; and
program instructions to determine bandwidth partitioning rules for the cluster of users based on the identified static bandwidth partitioning policies and identified historical bandwidth usage data.

16. The computer system of claim 15, further comprising program instructions to:
apply the determined bandwidth partitioning rules to the cluster of users.

17. The computer system if claim 15, wherein the cluster of users are a group of users that receive internet connection bandwidth from an internet service provider and are clustered based on physical proximity.

18. The computer system of claim 15, further comprising program instructions to:
receive, for each individual or group of individuals in the cluster of users, historical bandwidth usage data,
wherein the received historical bandwidth usage data is stored and includes an associated indication of the corresponding user or group of users, application, amount of bandwidth utilizes, duration of time, and time of day.

19. The computer system of claim 15, wherein the program instructions to determine bandwidth partitioning rules for the cluster of users based on the identified static bandwidth partitioning policies and identified historical bandwidth usage data, further comprise program instructions to:
utilize the identified static bandwidth partitioning policies as an initial set of bandwidth partitioning rules; and
customize the initial set of bandwidth partitioning rules based on the identified historical bandwidth usage data,
wherein the determined bandwidth partitioning rules include internet connection bandwidth quotas for each individual or group of individuals in the cluster of users and an indication of activation and deactivation times.

20. The computer system of claim 15, further comprising program instructions to:
responsive to receiving an updated instance of historical bandwidth usage data, determine an updated set of bandwidth partitioning rules based on the identified static bandwidth partitioning policies and the received updated historical bandwidth usage data.
